(19) United States
(12) Patent Application Publication
(10) Pub. No.: US 2017/0075397 A1
(43) Pub. Date: Mar. 16, 2017

(54) CIRCUITS AND METHODS PROVIDING TEMPERATURE MITIGATION FOR COMPUTING DEVICES

(71) Applicant: QUALCOMM Incorporated, San Diego, CA (US)

(72) Inventors: Mehdi Saeidi, San Diego, CA (US); Arpit Mittal, San Diego, CA (US); Farsheed Mahmoudi, San Diego, CA (US); Rajat Mittal, San Diego, CA (US)

(21) Appl. No.: 14/852,941

(22) Filed: Sep. 14, 2015

(51) Int. Cl. G06F 1/20; G06F 1/32

(52) U.S. Cl. CPC G06F 1/206; G06F 1/3206; G06F 1/3234; G06F 1/324

(57) ABSTRACT

A method includes: generating a power consumption reading indicative of power consumption of a device, comparing the power consumption reading to a power threshold, wherein the power threshold represents a level of power consumption corresponding to a rise in temperature of an exterior surface of the device; in response to determining that the power consumption reading exceeds the power threshold, measuring cumulative power consumption over time from the power consumption reading; comparing the cumulative power consumption over time to an energy threshold, wherein the energy threshold corresponds to a temperature threshold for the exterior surface of the device; and in response to determining that the cumulative power consumption over time exceeds the energy threshold, reducing an operating parameter of the device to reduce power consumption.

### TECHNICAL FIELD

This application relates to thermal mitigation and, more specifically, to providing thermal mitigation to a computing device in response to measured power consumption of the device.

### BACKGROUND

A conventional modern smart phone may include a system on chip (SOC), which has a processor and other operational circuits. Specifically, an SOC in a smart phone may include a processor chip within a package, where the package is mounted on a printed circuit board (PCB) internally to the phone. The phone includes an external housing and a display, such as a liquid crystal display (LCD). A human user when using the phone physically touches the external housing and the display.

As the SOC operates, it generates heat. In one example, the SOC within a smart phone may reach temperatures of 80° C.-100° C. Furthermore, conventional smart phones do not include fans to dissipate heat. During use, such as when a human user is watching a video on a smart phone, the SOC generates heat, and the heat is spread through the internal portions of the phone to the outside surface of the phone.

The outside surface of the phone is sometimes referred to as the “skin.” The outside surface includes the part of the external housing that is physically on the outside of the phone as well as any other externally-exposed portions, such as an LCD display. It is generally accepted that the skin of the phone should not reach temperatures higher than about 40° C.-45° C. due to safety and ergonomic reasons. As noted above, the SOC within the smart phone may reach temperatures of 80° C.-100° C., although the temperature of the SOC is not felt directly at the skin of the phone. Instead, heat dissipation within the phone often means that the skin temperature of the phone is at a lower temperature than the SOC temperature. Furthermore, whereas changes to SOC temperature may be relatively quick (e.g., seconds), changes to device skin temperature may be relatively slow (e.g., tens of seconds or minutes).

Conventional smart phones include algorithms to control the skin temperature by reducing a frequency of operation of the SOC when a temperature sensor on the SOC reaches a threshold level. However, SOC temperature can be a poor proxy for device skin temperature.

### SUMMARY

Various embodiments include systems and methods that mitigate temperature by measuring power consumption and reducing performance of a processor, if appropriate, based at least in part on the power consumption measurement.

In one embodiment, a method includes generating a power consumption reading that is indicative of power consumption of a computing device. For instance, the computing device may be a smart phone, tablet, or other device. The example method also includes comparing the power consumption reading to a power threshold, wherein the power threshold represents a level of power consumption corresponding to a rise in temperature of an external surface of the computing device. In response to determining that the power consumption reading exceeds the power threshold, the method further includes measuring cumulative power consumption over time from the power consumption reading. The cumulative power consumption over time is compared to an energy threshold, and in response to determining that the cumulative power consumption over time exceeds the energy threshold, the method includes reducing an operating parameter of the device to reduce power consumption. For instance, the operating parameter may include frequency of operation, voltage of operation, or other parameters.

In another embodiment, a system includes a computer processor configured to execute machine-readable instructions and to consume power from a system battery, and a physical housing that encloses at least part of the system. The computer processor is enclosed within the physical housing and is in thermal contact with the physical housing. The system also includes a power indicating device disposed within the physical housing, where examples of power indicating devices include current measurement devices and power measurement devices. The processor is configured to calculate a cumulative power consumption from a reading of the power indicating device, compare the cumulative power consumption over time of the system to an energy threshold, and reduce an operating parameter of the computer processor in response to determining that the cumulative power consumption over time of the system exceeds the energy threshold.

In yet another embodiment, a computer program product having a computer readable medium tangibly recording computer program logic for mitigating temperature of a computing device includes code to compare a power consumption of the computing device to a power threshold corresponding to a rise in temperature of an external surface of the computing device. The computer program product also includes code to compare a cumulative power consumption of the computing device to an energy threshold, corresponding to a temperature threshold of the external surface of the computing device, in response to determining that the power consumption exceeds the power threshold, and code to reduce a frequency of operation of the computing device in response to determining that the cumulative power consumption exceeds the energy threshold.

### BRIEF DESCRIPTION OF THE DRAWINGS

FIG. 1 is an illustration of an example computing device that may perform a method according to various embodiments.

FIG. 2 is an illustration of the internal functional units of the computing device of FIG. 1, according to one embodiment.

FIG. 3 is an illustration of the computer processor of FIG. 2, according to one embodiment.

FIG. 4 is an illustration of power thresholds of an example device, adapted according to one embodiment.

FIG. 5 is an illustration of a flow diagram of an example method of thermal mitigation.

### DETAILED DESCRIPTION

Various embodiments provided herein include systems and methods to mitigate temperature of a computing device. For instance, various embodiments described herein use power measurement in addition to, or instead of, temperature measurement as a basis for a thermal mitigation algorithm.

In one embodiment, a computer processor includes a system on chip (SOC) that has a number of processing cores and is associated with a power supply. The SOC and the power supply are disposed within a computing device, such as a smart phone. The smart phone also includes a battery, a printed circuit board hosting the SOC and power supply, a touchscreen display, and an outer housing, among other things. The power supply converts the voltage and current from the battery into a voltage and current that can be used by the SOC. As the SOC operates, it produces heat.

The heat from the SOC spreads throughout the phone according to the heat conduction properties of the physical materials that make up the phone. However, it is generally expected that the skin of the phone will not be as hot as the SOC, at least under usual operating conditions. The system includes one or more processes that monitor power use of the computer processor. For instance, in one embodiment a current sensor on a battery rail may measure the current, and power is determined from the current since the voltage is known. In another embodiment, one or more current sensors between the power supply and the SOC may measure current consumption by the SOC, which can be translated into power when voltage is known. In yet another embodiment, a current sensor specific to one or more cores of the SOC may provide an indication of current consumption by those one or more cores. Once again, current consumption can be translated into a power reading when voltage is known. In fact, the scope of embodiments may include measuring current consumption at any appropriate component of the system. In another embodiment, one or more digital power meters (DPMs) may be used at any appropriate part of the system to provide an indication of power consumption.

A process, either hardware-based or software-based or combination thereof, uses the power reading for thermal mitigation. Specifically, in this example, the process compares the power reading to a first threshold to determine whether the power reading goes above the first threshold. If the power reading stays below the first threshold, then the process keeps monitoring without providing thermal mitigation action. If the power reading is above the first threshold, then the process moves to another action that includes measuring a cumulative power consumption over time. If the cumulative power consumption over time crosses a second threshold, then the process begins thermal mitigation by, e.g., reducing a clock frequency of the processor. If the cumulative power consumption over time does not cross the second threshold, then the process continues to monitor the cumulative power consumption over time until the measured power consumption drops below the first threshold.

The process described above may be embodied as computer executable code that is read from a tangible computer-readable medium and executed by a kernel process of the processor. In another embodiment, the process may be embodied as a hardware process built in to the processor. However, in many embodiments, thermal changes at the skin of the device and at the SOC change on the order of seconds or minutes, so that software is generally fast-acting enough.

Other embodiments include methods to perform the process described above. For example, a method may include generating a power consumption reading in the device and comparing it to a first power threshold. In response to the power reading exceeding the first power threshold, the processor compares the cumulative power consumption over time to a second threshold. In response to the cumulative power consumption over time exceeding the second threshold, the processor reduces its operating frequency, thereby reducing the amount of power consumed and heat generated.

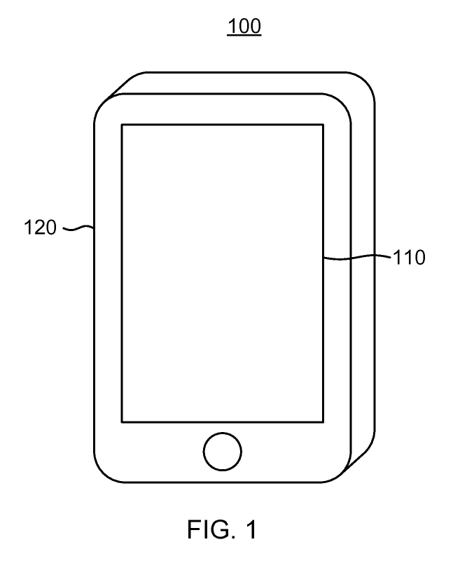

FIG. 1 is a simplified diagram illustrating an example computing device 100 in which various embodiments may be implemented. In the example of FIG. 1, computing device 100 is shown as a smart phone. However, the scope of embodiments is not limited to a smart phone, as other embodiments may include a tablet computer, a laptop computer, or other appropriate device. In fact, the scope of embodiments includes any particular computing device, whether mobile or not. Embodiments including battery-powered devices, such as tablet computers and smart phones may benefit from the concepts disclosed herein. Specifically, the concepts described herein provide techniques to reduce heat that is dissipated outside of computing device 100, thereby providing comfort for a human user and conserving battery power.

As shown in FIG. 1, computing device 100 includes an outer surface or skin 120, which may be expected to come into contact with hands or other parts of the body of a human user. The outside surface 120 includes, e.g., metal surfaces and plastic surfaces and the surfaces that make up display unit 110. In one example, display unit 110 is a capacitive liquid crystal display (LCD) touchscreen, so that the surface of display unit 110 is either glass or plastic-coated glass. The outside surface 120 therefore includes the various external surfaces such as the display unit 110 and the other parts of the external housing. Although not shown in the vantage point of FIG. 1, the back side of computing device 100 includes another part of the outer surface of the device, and specifically another part of the exterior housing, which may be arranged in a plane parallel to a plane of display unit 110.

FIG. 1 does not show a computer processor, but it is understood that a computer processor is included within computing device 100. In one example, the computer processor is implemented in a system on chip (SOC) within a package, and the package is mounted to a printed circuit board and disposed within the physical housing. In conventional smart phones, the package including the processor is mounted in a plane parallel to a plane of the display surface and a plane of the back surface.

As a computer processor operates, it produces heat, which dissipates throughout the physical structure of computing device 100. Depending on the specific thermal properties of computing device 100, heat from the operation of the processor may reach uncomfortable or near-uncomfortable temperatures on the outside surface 120 of computing device 100. The computer processor within computing device 100 provides functionality to control the heat felt on the outside surface of the computing device 100 by measuring power consumption and adjusting a frequency and/or voltage of the processor if appropriate.

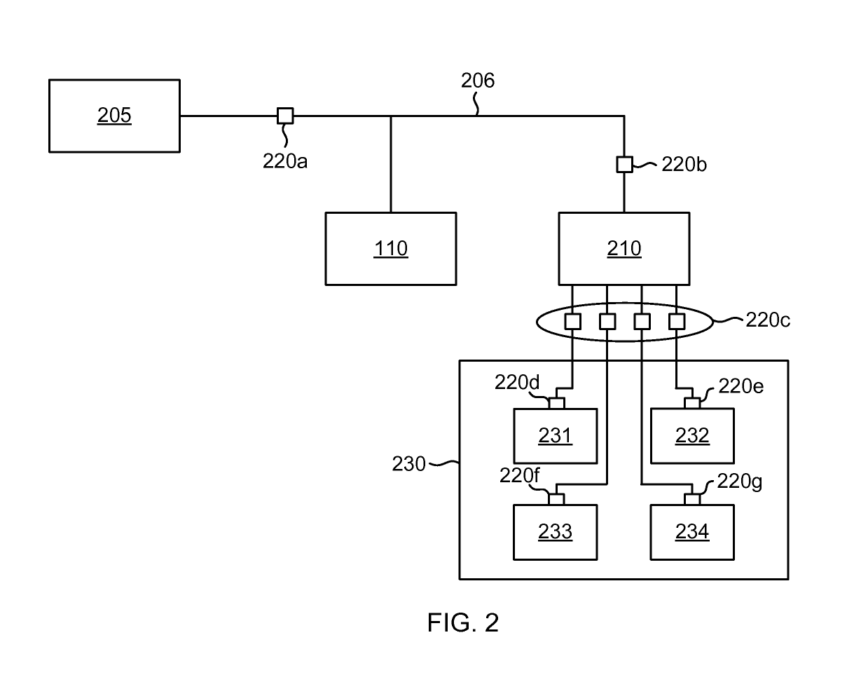

FIG. 2 is an architectural diagram of an example physical layout of the internal functional components of computing device 100 of FIG. 1, according to one embodiment. FIG. 2 is intended to be illustrative, and it omits some features for ease of illustration.

Battery 205, power management integrated circuit (PMIC)210, and SOC 230 are disposed within the computing device 100 so that they are enclosed within the physical housing of the computing device 100 as indicated by exterior surface 120. Battery 205, PMIC 210, and SOC 230 are also in thermal contact with the physical housing so that the heat generated by those items is conducted to the exterior surface 120 of the device 100.

Computing device 100 includes battery 205, which may be any appropriate battery now known or later developed. For instance, battery 205 may include a lithium-ion battery or other power source. Battery 205 is coupled to battery rail 206, which distributes power from the battery 205. Battery rail 206 is coupled to device display 110 and to power management integrated circuit (PMIC) 210. In some embodiments, the power from battery rail 206 may be regulated or otherwise conditioned before being provided to display 110, however for ease of illustration, battery rail 206 in this example is provided directly to display 110. Current measurement device 220a is provided to measure the current on battery rail 206.

PMIC 210 receives power from battery rail 206 and regulates the voltage to provide an output voltage that is usable by SOC 230. In this example, current measurement device 220b is placed on the battery rail in a location so that it measures an amount of current provided to PMIC 210 but does not directly measure current provided to display device 110. Therefore, current measurement device 220b may be used to provide an indication as to power consumption of SOC 230.

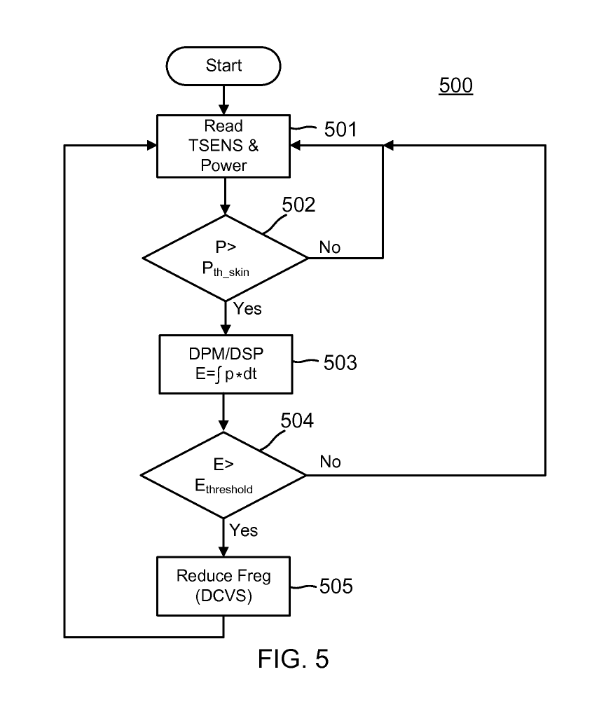

SOC 230 has four cores, 231-234. Examples of cores include a central processing unit (CPU), a graphics processing unit (GPU), a modem, and the like. Although not shown in FIG. 2, a clocking circuit provides a clock signal with an operating frequency to each of the cores 231-234, where the clocking circuit may be controlled to increase or decrease the operating frequency. In some examples, thermal mitigation may be performed by reducing an operating frequency of the cores 231-234 by performing the algorithm of FIG. 5. PMIC 210 provides power to SOC 230, and specifically provides power to the cores 231-234 by four separate power rails in this embodiment. The scope of embodiments is not limited to any particular SOC architecture, as any appropriate number of cores and PMIC power rails may be used in a particular embodiment. For instance, other embodiments may include 16 cores, 32 cores, or other number.

Further shown in FIG. 2, each of the four PMIC power rails includes a respective current measurement device 220c, each of the respective current measurement devices 220c is associated with a particular one of the cores 231-234. Therefore each one of the current measurement devices 220c may provide an indication of the current consumed by its corresponding core. Also, current measurement devices 220c in the aggregate may provide a summed measurement for total current consumed by cores 231-234.

Additionally, this embodiment also includes current measurement devices 220d-g, where each one of the devices 220d-g is associated with a particular one of the cores 231-234. Each of the current measurement devices 220d-g may be included for instance in a global distributed head switch (GDHS) associated with its corresponding core 231-234. For instance, some conventional systems may include a GDHS with each of the cores 231-234, and various embodiments described herein may use the current measurement functionality already included in the GDHSs.

SOC 230 includes functionality to derive power use from various current measurement data provided by current measurement devices 220. The architecture of FIG. 2 provides a variety of different options for measuring current in the device 100 of FIG. 1. For instance, if the thermal mitigation algorithm is designed to take into account power used by display 110 and SOC 230, then the thermal mitigation algorithm may be well served by receiving current measurement data from current measurement device 220a. On the other hand, if the thermal mitigation algorithm is designed to address only heat generated by the operation of SOC 230, then the thermal mitigation algorithm may receive current measurement data from current measurement device 220b, 220c, and/or 220d-g. In other embodiments, the thermal mitigation algorithm may be designed to take into account the heat generated by only a subset of the cores 231-234, in which case appropriate ones of the measurement devices 220c and/or 220d-g may be selected to provide current measurement data.

The scope of embodiments is not limited to current measurements only. Rather, other embodiments may include one or more DPMs placed at any of a variety of locations to measure power consumption on the battery rail as a whole or to various functional units (e.g. display 110 and SOC 230) individually. In an embodiment wherein current measurements are provided to the thermal mitigation algorithm, the thermal mitigation algorithm may derive power readings by for instance multiplying current by voltage. On the other hand, DPMs may provide an indication of power to the thermal mitigation algorithm.

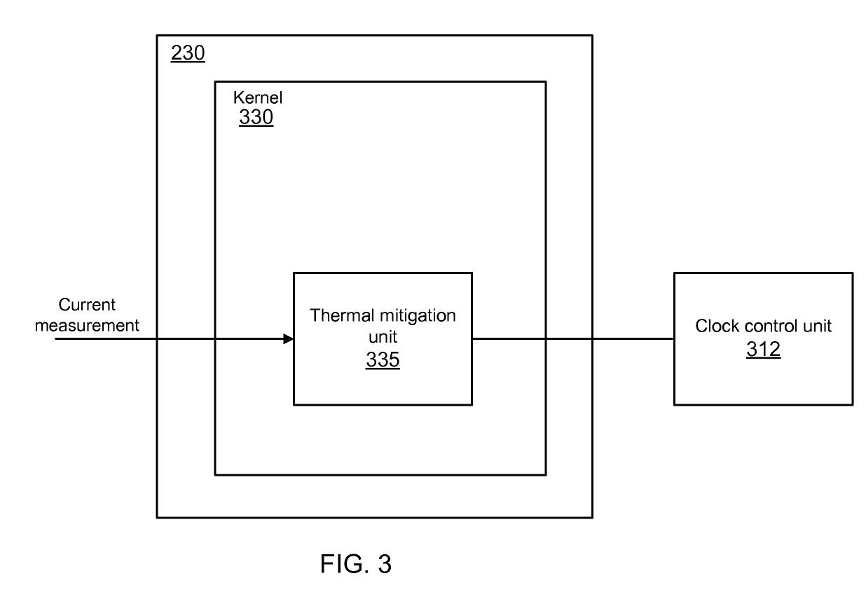

FIG. 3 provides an illustration of an example system that performs the methods described herein. Specifically, FIG. 3 is an illustration of the thermal mitigation processes provided by SOC 230.

SOC 230 includes a software kernel 330, which operates when SOC 230 is powered up and receiving a clock signal. Thermal mitigation unit 335 is a software process that is built into kernel 330, and it performs the method described with respect to FIG. 5. Additionally or alternatively, thermal mitigation unit 335 may be built as a hardware process.

Thermal mitigation unit 335 receives one or more current measurements from current measurement devices. Examples of current measurement devices include those shown in FIG. 2. The thermal mitigation unit 335 calculates power consumption information from the current measurements and provides mitigation, when appropriate, according to the method of FIG. 5. In an embodiment wherein DPMs are used instead of current measurement devices, thermal mitigation unit 335 may avoid translating current data into power data, but still performs the method of FIG. 5.

Thermal mitigation unit 335 may reduce the clock frequencies provided to the cores or increase the clock frequencies provided to the cores by sending commands to clock control unit 312. Clock control unit 312 may be physically a part of SOC 230 or separate therefrom, as the scope of embodiments is not limited to any particular clocking architecture. Clock control unit 312 may control for instance a phase locked loop (PLL) or other appropriate circuit that provides a periodic clock signal in order to raise or lower the operating frequency of one or more of the cores 231-234.

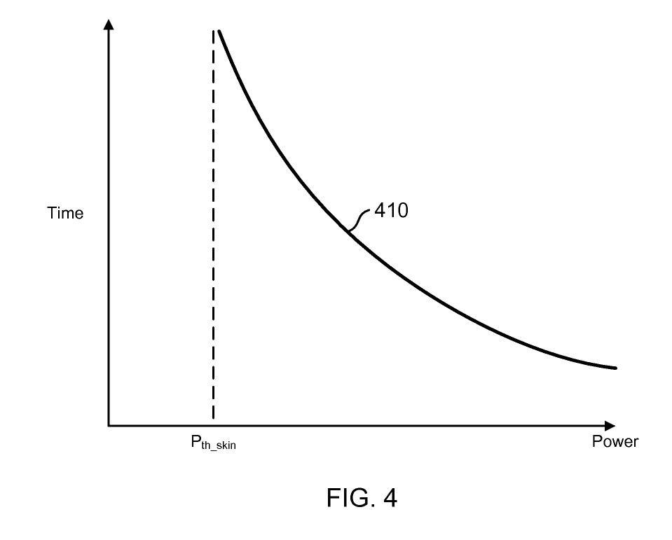

FIG. 4 is a graph of an example power mitigation curve, according to one embodiment. A given computing device, such as computing device 100 of FIG. 1, is made of various physical materials that cause the device to have particular thermal conductive properties. For instance, some computing devices may include a specially designed heat spreader that is internal to the housing and placed between an inside surface of the housing and the computer processor within the device. A well-functioning heat spreader may keep the heat that is generated by the processor from being concentrated at one area of the housing, thereby maintaining a more uniform heat profile around the surface of the computing device. Since the heat is spread to more surface area, the heat may be removed by ambient air more efficiently, thereby allowing more heat generation by the SOC before thermal mitigation becomes appropriate.

On the other hand, some computing devices may have different levels of heat spreading, such that heat from the SOC is conducted from the SOC less evenly. Therefore, the heat is concentrated to specific areas of the skin of the device. Such areas may become heated more quickly, and the heat may be removed from the surface by ambient air less efficiently since less surface area is heated. Such a computing device may utilize thermal mitigation algorithms more often in order to avoid heating those specific areas beyond a level that is comfortable for a human user.

Each model of computing device has its own thermal properties. Therefore, a thermal algorithm that is designed specifically for a particular model of computing device may not work well for different models of computing devices. Returning to the graph of FIG. 4, the X axis represents power, and the Y axis represents time. Pth_skin is a first threshold, and it corresponds to a power consumption level, where power consumption at that level or below is unlikely to cause an increase in device skin temperature that is enough to reach an uncomfortable level. Of course, an uncomfortable level may be set by engineers to be 40° C.-45° C. or other appropriate temperature level. Furthermore, Pth_skin may be different for different device models and types. As explained above, the thermal conductive properties of a particular device depends upon the physical makeup and arrangement of the materials of the device.

In some embodiments, Pth_skin may be a design parameter that is known by simulation during the design phase of the device. In other embodiments, Pth_skin may be determined through experimentation with a physical embodiment of the device. For instance, a computer-aided design program may be used by a designer to determine the heat conductive properties of the device as the devices being designed. Additionally or alternatively, a designer may test power consumption and take temperature readings of the skin of the device in a controlled environment in order to determine a value for Pth_skin. Such design and/or testing may be performed by a designer or manufacturer of the device.

Once power consumption exceeds the threshold Pth_skin, power use above that threshold is expected to increase the skin temperature up to an uncomfortable level, unless power use is decreased. Higher levels of power use are also expected to increase skin temperature more quickly than lower levels of power use. Accordingly, curve 410 represents a boundary above which thermal mitigation is invoked according to the method of FIG. 5. However, cumulative power use below curve 410 may not result in invocation of thermal mitigation, assuming that power use eventually decreases below Pth_skin. The area under curve 410 is the integral of power over time, energy.

As with Pth_skin, the level of the boundary of curve 410 is specific to a particular device model and type. In this example, the level of the boundary of curve 410 corresponds to a skin temperature threshold so that a cumulative power consumption over a certain amount of time, exceeding the boundary of the curve 410, would be expected to cause the skin temperature of the device to reach a pre-defined uncomfortable level, such as 40° C.-45° C. The level of the boundary of curve 410 depends upon the specific thermal conductive properties of a particular device. Those thermal conductive properties may be known through design and/or experimentation. Therefore, a designer using computer-aided design may determine the boundary of curve 410, or the designer may use experimentation on a physical implementation of the device to determine the boundary of curve 410. While the boundary of curve 410 is shown as a curve approaching zero as power increases, the scope of embodiments may include any appropriately shaped curve that uses power consumption as a proxy for skin temperature of the device. For example, in other embodiments, the relationship expressed by curve 410 may be linear.

In one example use case, a manufacturer or designer of a computing device determines Pth_skin and the boundary of curve 410. The designer or manufacturer then saves that information into memory of SOC 230 for use by thermal mitigation unit 335. This process is performed before delivering finished units to consumers, so that the finished product includes robust thermal mitigation functionality built into it.

A flow diagram of an example method 500 of providing thermal mitigation is illustrated in FIG. 5. In one example, method 500 is performed by thermal mitigation unit 335, such as described above with respect to FIG. 3. Method 500 assumes that the boundary of curve 410 as well as the threshold Pth_skin are already known for the particular device. As the device operates during normal use, thermal mitigation unit 335 performs the actions of method 500. Therefore, as a human user leaves the device idle, makes phone calls, sends text messages, watches videos, and the like, thermal mitigation unit 335 continually performs the actions 500 to ensure that the device skin temperature does not reach a pre-defined uncomfortable level.

At action 501, the thermal mitigation unit 335 reads temperature sensing data (TSENS) and a power sensing data. As noted above, power sensing data may be derived from one or more current measurements or may be provided directly by a power measurement sensor. The rest of this description will focus on power measurement and will not consider the temperature sensor reading itself. Nevertheless, it is understood that various embodiments may be performed in addition to other processes that use temperature sensing.

At action 502, the thermal mitigation unit 335 compares the measured power reading (e.g., in Watts) against a power threshold, Pth_skin. The value of the power threshold may be any appropriate amount, and it represents a level of power consumption that may be expected to begin an undesirable rise in device skin temperature. The value of the power threshold will depend on the heat conduction properties of the particular device. For instance, a device with a heat spreading layer built into it may be assigned a higher power threshold than a device that allows a more rapid heat transfer from the SOC to the skin. In some scenarios, the power threshold may be assigned to a device based upon experimentation and/or known heat transfer properties of the design. As noted above, Pth_skin may be saved to memory in the processor of the device and accessed by thermal mitigation unit 335 as it performs method 500.

If the measured power reading is not greater than the power threshold, then the thermal mitigation unit 335 continues to monitor the power sensor. However, if the measured power reading is greater than the power threshold, the thermal mitigation unit 335 moves to action 503. At action 503 the thermal mitigation process measures power consumption over time. An example includes integrating power consumption over a particular time period. Another example is a cumulative, moving window average of power consumption over time.

At action 504, the thermal mitigation process determines whether the power consumption over the time period is greater than an energy threshold (Ethreshold), where the energy threshold corresponds to amount of energy expected to cause an undesirably high device skin temperature. (e.g., 43° C.). The energy threshold is specific to a particular device design, and may be assigned to a particular device through experimentation and/or known heat transfer properties of the design. In the particular example of FIG. 4, the energy threshold corresponds to the boundary of curve 410.

In one particular use case, the action 504 performs the following calculation according to equation 1:

E/ΔT>E_{threshold}/ΔT_{device}, (1)

where ΔT is the amount of time over which the calculation of action 503 is integrated, and wherein ΔTdevice is determined by the shape of the curve 410. For instance, the calculation of action 503 may be performed and accumulated at predefined times, so that the value of E gets larger as time continues and as long as the power measurement does not drop below Pth_skin. The calculation of action 504 divides E by that window of time that has elapsed and compares it to Ethreshold normalized by ΔTdevice. Therefore, the actions of blocks 503 and 504 calculate a cumulative power consumption over time and compare the cumulative power consumption to an energy threshold normalized by ΔTdevice to provide a threshold power consumption over time. In another embodiment, action 503 includes calculating a cumulative, moving window average of power consumption over a defined time period.

If the power consumption over the time period is less than the energy threshold, then the thermal mitigation unit 335 continues to monitor the power consumption. If the power consumption over time is greater than the energy threshold, then the thermal mitigation unit 335 moves to action 505.

At action 505, the thermal mitigation unit 335 reduces the energy consumed by the SOC. In one example, the thermal mitigation process reduces an operating frequency of one or more cores in the SOC, thereby reducing power consumption. However, the scope of embodiments may include any appropriate thermal mitigation technique, such as putting cores in an idle state. For instance, in the example of FIG. 3, thermal mitigation unit 335 may send commands to clock control unit 312 to reduce the clock frequency or gate the clock frequency altogether. In fact, reduction of any operating parameter, such as frequency or voltage, is within the scope of embodiments. The process continues to operate as the SOC operates, continually measuring the power consumption and taking appropriate mitigation steps according to the algorithm.

The scope of embodiments is not limited to the specific method shown in FIG. 5. Other embodiments may add, omit, rearrange, or modify one or more actions. For instance, method 500 may also include functionality to return the clock frequency to a previous level or otherwise to increase the clock frequency when thermal mitigation is no longer desired, such as after determining that power consumption has decreased.

Furthermore, some embodiments may use power measurements for any relevant portion of the computing device. For example, as shown above in FIG. 2, there are a variety of different choices for gathering power management data. In some instances, the current consumed by the processor itself may be more relevant to thermal temperature at the skin of the device than would be the current consumed by the display unit. In such an instance, the power measurement gathered at action 501 may focus on current consumed by the processor itself and omit consideration of other current used by the display device. On the other hand, in some devices current consumed by units other than the processor may be relevant to the skin temperature, in which case their power consumption may be taken into account in the calculations of method 500.

Various embodiments may provide one or more advantages over conventional solutions. For instance, it may be difficult to capture a temperature reading directly from the skin of a computing device, especially for more compact and mobile computing devices such as phones and tablets. Nevertheless, skin temperature can be very relevant to a user's perception of comfort. Some conventional solutions use temperature readings gathered from sensors on the processor and base thermal mitigation decisions on that temperature reading. But temperature readings gathered from thermal sensors on the processor may not provide an accurate indication of skin temperature, thereby causing intervention of a thermal mitigation process too early or too often and sacrificing performance of the system.

By contrast, the systems described herein provide thermal mitigation using power consumption as a proxy for temperature. Ultimately, temperatures affecting the skin of the device are generally expected to be caused by power consuming units within the computing device, and the embodiments described above provide a solution to monitor power consumption and to provide thermal mitigation in view of the power consumption of the device. When paired with device-specific data to provide the power threshold and a mitigation curve, such as that shown in FIG. 4, some embodiments described herein may provide effective thermal mitigation without sacrificing performance.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method comprising:
generating a power consumption reading indicative of power consumption of a device;
comparing the power consumption reading to a power threshold, wherein the power threshold represents a level of power consumption corresponding to a rise in temperature of an exterior surface of the device;
in response to determining that the power consumption reading exceeds the power threshold, measuring cumulative power consumption over time from the power consumption reading;
comparing the cumulative power consumption over time to an energy threshold, wherein the energy threshold corresponds to a temperature threshold for the exterior surface of the device; and
in response to determining that the cumulative power consumption over time exceeds the energy threshold, reducing an operating parameter of the device to reduce power consumption.

2. The method of claim 1, wherein the power consumption reading is based on a measurement of current from a battery rail of the device.

3. The method of claim 1, wherein the power consumption reading is based on a measurement of current from a power management integrated circuit to a system on chip (SOC) of the device.

4. The method of claim 1, wherein the power consumption reading is based on a measurement of current provided to a central processing unit (CPU) of the device.

5. The method of claim 1, wherein measuring the cumulative power consumption over time comprises:
calculating an integral of power consumption over time for a defined time period.

6. The method of claim 1, wherein measuring the cumulative power consumption over time comprises:
calculating a cumulative, moving window average of power consumption over a defined time period.

7. The method of claim 1, wherein the method is performed by a software kernel of a processing chip of the device.

8. The method of claim 1, wherein the device comprises a handheld computing device having a system on chip (SOC) therein, wherein the SOC compares the power consumption reading to the power threshold and compares the cumulative power consumption over time to the energy threshold.

9. The method of claim 1, wherein reducing the operating parameter of the device comprises:
reducing an operating frequency of a computer processor of the device.

10. The method of claim 1, wherein reducing the operating parameter of the device comprises:
gating a clock of a computer processor of the device.

11. The method of claim 1, further comprising:
increasing the operating parameter of the device after determining that power consumption has decreased.

12. A system comprising:
a computer processor configured to execute machine-readable instructions and to consume power from a system battery;
a physical housing enclosing at least a portion of the system, the computer processor being disposed within the system so that it is enclosed within the physical housing, the computer processor further being in thermal contact with the physical housing; and
a power indicating device disposed within the physical housing and in communication with the computer processor, the computer processor configured to perform the following operation:
calculate a cumulative power consumption from a reading of the power indicating device;
compare the cumulative power consumption over time of the system to an energy threshold, wherein the energy threshold corresponds to a temperature threshold for an exterior surface of the physical housing; and
in response to determining that the cumulative power consumption over time of the system exceeds the energy threshold, reduce an operating parameter of the computer processor.

13. The system of claim 12, wherein the system is at least one of a smart phone and a tablet computer.

14. The system of claim 12, wherein the power indicating device comprises a current sensor.

15. The system of claim 12, wherein the power indicating device comprises a plurality of current sensors.

16. The system of claim 12, wherein the operating parameter of the computer processor comprises an operating frequency.

17. The system of claim 12, wherein the computer processor is further configured to perform the following operation:
increase the operating parameter of the computer processor in response to determining that power consumption of the system has decreased.

18. The system of claim 12, wherein comparing the cumulative power consumption over time of the system to the energy threshold is performed in response to determining that a power consumption of the system has increased past a power threshold.

19. The system of claim 12, wherein the computer processor is implemented in a system on chip (SOC) within a package, wherein the package is mounted to a printed circuit board and disposed within the physical housing.

20. The system of claim 12, wherein the exterior surface of the physical housing comprises a display surface of a liquid crystal display (LCD) unit and an opposing surface, the computer processor being mounted in a plane parallel to a plane of the display surface and a plane of the opposing surface.

21. A system comprising:
means for providing data indicating power usage of the system;
means for calculating a cumulative power consumption from the data indicating power usage of the system and for comparing the cumulative power consumption of the system to an energy threshold; and
means for reducing an operating parameter of the means for calculating in response to determining that the cumulative power consumption exceeds the energy threshold; and
a physical housing enclosing at least a portion of the system, the means for calculating being enclosed within the physical housing, the means for calculating further being in thermal contact with the physical housing, further wherein the energy threshold corresponds to a temperature threshold for an exterior surface of the physical housing.

22. The system of claim 21, wherein the means for providing data indicating power usage of the system comprises a plurality of current measurement devices.

23. The system of claim 21, wherein the means for calculating comprises a system on chip (SOC) having multiple processing cores.

24. The system of claim 21, wherein the operating parameter comprises an operating frequency.

25. The system of claim 21, wherein the means for reducing the operating parameter comprises a clock controller in communication with the means for calculating.

26. The system of claim 21, wherein the system is at least one of a smart phone and a tablet computer.

27. A computer program product having a computer readable medium tangibly recording computer program logic for mitigating temperature of a computing device, the computer program product comprising:
code to compare a power consumption of the computing device to a power threshold corresponding to a rise in temperature of an external surface of the computing device;
code to compare a cumulative power consumption of the computing device to an energy threshold, corresponding to a temperature threshold of the external surface of the computing device, in response to determining that the power consumption exceeds the power threshold; and
code to reduce a frequency of operation of the computing device in response to determining that the cumulative power consumption exceeds the energy threshold.

28. The computer program product of claim 27, further comprising:
code to increase the frequency of operation of the computing device in response to determining that the power consumption has decreased.

29. The computer program product of claim 27, further comprising:
code to read a current consumption measurement and calculate the power consumption from the current consumption.

30. The computer program product of claim 27, wherein the energy threshold comprises an energy value normalized by a time value.
